(19) United States
(12) Patent Application Publication
(10) Pub. No.: US 2010/0264797 A1
(43) Pub. Date: Oct. 21, 2010

(54) REFLECTION-TYPE LIGHT-EMITTING MODULE WITH HIGH HEAT-DISSIPATING AND HIGH LIGHT-GENERATING EFFICIENCY

(76) Inventors: Bily WANG, Hsinchu City (TW); Ping-Chou Yang, Yonghe City (TW); Yu-Jen Cheng, Taian City (TW)

Correspondence Address: Muncy, Geissler, Olds & Lowe, PLLC, 4000 Legato Road, Suite 310, FAIRFAX, VA, 22033, US

(21) Appl. No.: 12/426,621

(22) Filed: Apr. 20, 2009

(51) Int. Cl. H01J 61/52

(52) U.S. Cl. 313/46

(57) ABSTRACT

A reflection-type light-emitting module with high heat-dissipating and high light-generating efficiency includes a reflection-type lampshade unit, a heat pipe unit and a light-emitting unit. The reflection-type lampshade unit has an open casing, a receiving space formed in the open casing, and a first reflective structure is disposed in the receiving space and on an inner surface of the open casing. The heat pipe unit is received in the receiving space and is disposed on the open casing. The light-emitting unit is disposed on the heat pipe unit, and the light-emitting unit has a light-emitting face facing the inner surface of the open casing.

### BACKGROUND OF THE INVENTION

1. Field of the Invention

The present invention relates to a reflection-type light-emitting module, in particular, to a reflection-type light-emitting module with high heat-dissipating and high light-generating efficiency.

2. Description of Related Art

Before the invention of the light bulb, illuminating the world after the sun went down was a messy, arduous, hazardous task. It took a bunch of candles or torches to fully light up a good-sized room, and oil lamps, while fairly effective, tended to leave a residue of soot on anything in their general vicinity. With the invention of light bulb along and as the science of electricity really got going in the mid 1800s, the easy-to-use lighting technology was such an improvement over the old ways that the world never looked back.

Currently, the application of illuminating device can be categorized into two fields. One of which is the construction industry, that includes all sorts of lighting systems adapted for private housing units, commercial buildings, and public transportation systems like highway and railway, and so on, so as to achieve objects of comfort, beautification, and safety; another filed is the commercial goods, that includes all sorts of light source adapted for auto lamps, indoor lightings and consumer electronics, etc. As in the Year 2000, the largest demand for illuminating devices lays in the United State of American. Generally, the demand for illuminating devices is growing in a rapid path following the growth of global economy. Nevertheless, as the environmental awareness also grows with the global economy, it is in great demand to have green lighting systems for enhancing environmental protection and energy conservation.

Hence, How to design a light-emitting module with high heat-dissipating and high light-generating efficiency is very important problem.

### SUMMARY OF THE INVENTION

In view of the aforementioned issues, the present invention provides a reflection-type light-emitting module with high heat-dissipating and high light-generating efficiency. The present invention can generate high heat-dissipating efficiency (high heat-conducting efficiency) and high light-generating efficiency (high light utilization percent) by matching a heat pipe and a plurality of types of reflective structure.

To achieve the above-mentioned objectives, the present invention provides a reflection-type light-emitting module with high heat-dissipating and high light-generating efficiency, including: a reflection-type lampshade unit, a heat pipe unit and a light-emitting unit. The reflection-type lampshade unit has an open casing, a receiving space formed in the open casing, and a first reflective structure is disposed in the receiving space and on an inner surface of the open casing. The heat pipe unit is received in the receiving space and is disposed on the open casing. The light-emitting unit is disposed on the heat pipe unit, and the light-emitting unit has a light-emitting face facing the inner surface of the open casing.

Therefore, light beams generated by the light-emitting unit are reflected outside the reflection-type lampshade unit by using the first reflective structure, so that the present invention can generate high light-generating efficiency. Heat generated by the light-emitting unit can be transmitted to the reflection-type lampshade unit by using the heat pipe unit, so that the present invention can generate high heat-dissipating efficiency.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1A is a perspective, schematic view of the reflection-type light-emitting module according to the first embodiment of the present invention;

FIG. 1B is a lateral, cross-sectional, schematic view of the reflection-type light-emitting module according to the first embodiment of the present invention;

FIG. 1C is a lateral, cross-sectional, schematic view of the reflection-type light-emitting module using another type of receiving space according to the first embodiment of the present invention;

FIG. 1D is a partial, front, schematic view of the reflection-type light-emitting module using another type of first reflective structure according to the first embodiment of the present invention;

FIG. 2 is a lateral, cross-sectional, schematic view of the reflection-type light-emitting module according to the second embodiment of the present invention;

FIG. 3A is a lateral, cross-sectional, schematic view of the reflection-type light-emitting module according to the third embodiment of the present invention;

FIG. 3B is a perspective, schematic view of the third reflective structure mated with the heat pipe unit according to the third embodiment of the present invention;

FIG. 4 is a lateral, cross-sectional, schematic view of the reflection-type light-emitting module according to the fourth embodiment of the present invention;

FIG. 5 is a lateral, cross-sectional, schematic view of the reflection-type light-emitting module according to the fifth embodiment of the present invention;

FIG. 6A is a lateral, cross-sectional, schematic view of the reflection-type light-emitting module according to the sixth embodiment of the present invention;

FIG. 6B is a bottom, schematic view of the reflection-type light-emitting module according to the sixth embodiment of the present invention; and

FIG. 7 is a perspective, schematic view of the reflection-type light-emitting module according to the seventh embodiment of the present invention.

### DETAILED DESCRIPTION OF THE PREFERRED EMBODIMENTS

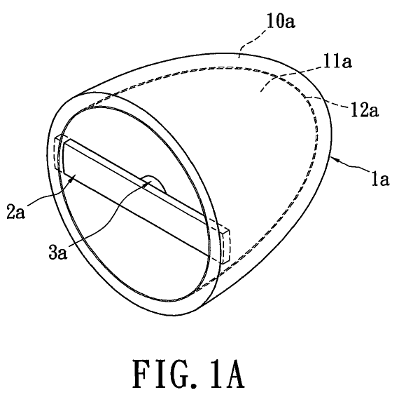

Referring to FIGS. 1A and 1B, the first embodiment of the present invention provides a reflection-type light-emitting module with high heat-dissipating and high light-generating efficiency, including: a reflection-type lampshade unit 1a, a heat pipe unit 2a and a light-emitting unit 3a.

The reflection-type lampshade unit 1a has an open casing 10a, a receiving space 11a formed in the open casing 10a, and a first reflective structure 12a disposed in the receiving space 11a and on an inner surface of the open casing 10a. In addition, in the first embodiment, the open casing 10a has a cup shape with an opening, and the inner surface of the open casing 10a can be a cambered surface. Moreover, the first reflective structure 12a can be a first reflective layer that is made of reflective material, and the open casing 10a has at least two retaining grooves 100a formed on the inner surface thereof.

However, the shape of the open casing 10a and the shape of the inner surface of the open casing 10a are just examples, and it does not limit the present invention. For example, referring to FIG. 11C, the receiving space 11a′ has a trapezoid; referring to FIG. 1D, the first reflective structure 12A′ can be composed of a plurality of mirrors 120a′, and the shape and the size of the mirror 120a′ can be adjusted according to different requirements.

Furthermore, the heat pipe unit 2a can be a heat pipe. The heat pipe unit 2a is received in the receiving space 11a and disposed on the open casing 10a, and two opposite ends of the heat pipe unit 2a are respectively retained in the two retaining grooves 100a.

Moreover, the light-emitting unit 3a can be an LED. The light-emitting unit 3a is disposed on the heat pipe unit 2a, and the light-emitting unit 3a has a light-emitting face 30a facing the inner surface of the open casing 10a. In other words, the light-emitting unit 3a is disposed on a bottom face of the heat pipe unit 2a, and the light-emitting face 30a faces the first reflective structure 12a. In addition, the light-emitting unit 3a can obtain power by an electric wire along the heat pipe unit 2a.

Hence, light beams La generated by the light-emitting unit 3a are reflected outside the reflection-type lampshade unit 1a by using the first reflective structure 12a, so that the present invention can generate high light-generating efficiency. Heat generated by the light-emitting unit 3a can be transmitted to the reflection-type lampshade unit 1a by using the heat pipe unit 2a, so that the present invention can generate high heat-dissipating efficiency.

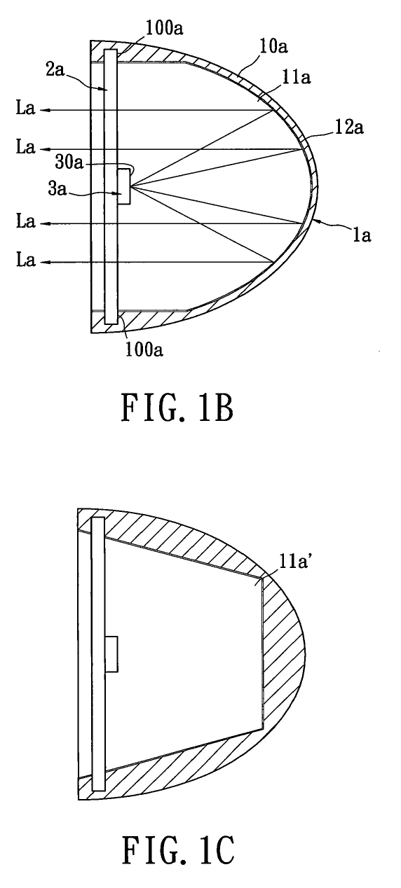

Referring to FIG. 2, the difference between the second embodiment and the first embodiment is that: the second embodiment further includes a second reflective structure 4b disposed on the inner surface of the open casing 10b. The second reflective structure 4b has a cone 40b and a second reflective layer 41b formed on the surface of the cone 40b. In addition, the cone 40b is composed of a cone portion 400b and a bottom portion 401b disposed under the cone portion 400b. The cone portion 400b faces the light-emitting face 30b of the light-emitting unit 3b, and the bottom portion 401b is disposed on the inner surface of the open casing 10b.

Hence, light beams Lb generated by the light-emitting unit 3b are effectively reflected outside the reflection-type lampshade unit 1b by matching the first reflective structure 12b and the second reflective structure 4b, so that the light-generating efficiency of the second embodiment is better than that of the first embodiment. In addition, the shadow of the light-emitting unit 3b on the inner surface of the open casing 10b can be solved by using the second reflective structure 4b. When the first reflective structure 12b is formed on the entire inner surface of the open casing 10b, the second reflective structure 4b can be disposed on the first reflective structure 12b directly.

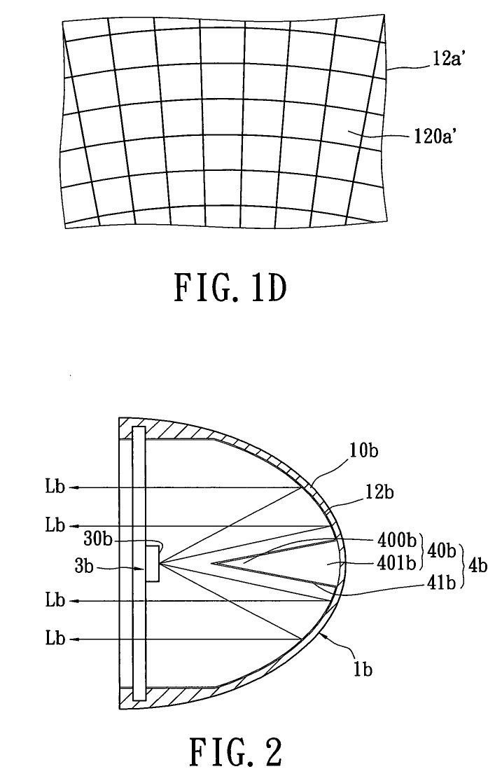

Referring to FIGS. 3A and 3B, the difference between the third embodiment and above-mentioned embodiments is that: the third embodiment further includes a third reflective structure 5c disposed on the heat pipe unit 2c. The third reflective structure 5c has a cone 50c and a third reflective layer 51c formed on the surface of the cone 50c. In addition, the cone 50c is composed of a cone portion 500c and a bottom portion 501c disposed under the cone portion 500c. The cone portion 500c faces downwards the first reflective structure 12c, and the bottom portion 501c is disposed on a bottom side of the heat pipe unit 2c. Hence, light beams Lc generated by the light-emitting unit 3c are effectively reflected outside the reflection-type lampshade unit 1c by matching the first reflective structure 12c and the third reflective structure 5c, so that the light-generating efficiency of the third embodiment is better than that of the first embodiment.

Furthermore, the first reflective structure, the second reflective structure and the third reflective structure can be mated with each other in order to obtain better light-generating efficiency.

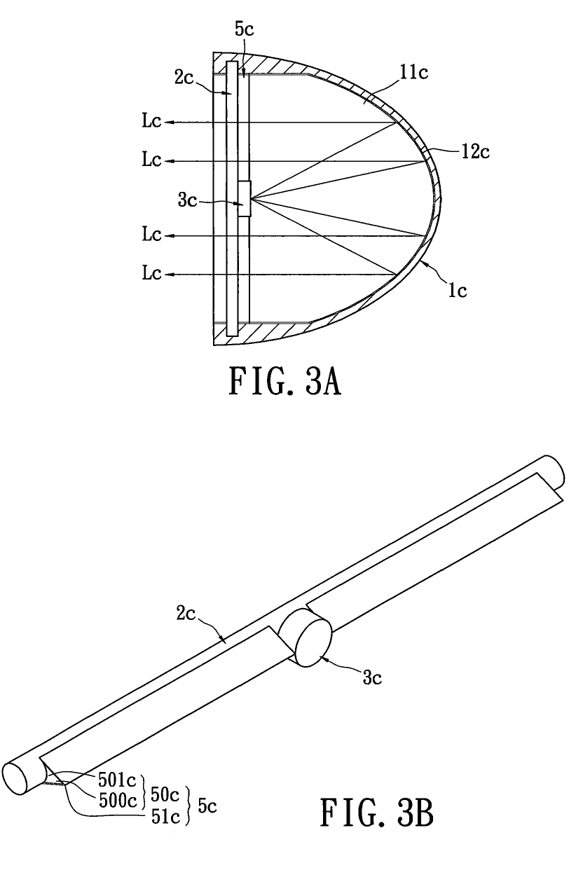

Referring to FIG. 4, the difference between the fourth embodiment and the first embodiment is that: in the fourth embodiment, the open casing 10d has at least one retaining groove 100d formed on the inner surface thereof. One end of the heat pipe unit 2d is retained in the retaining groove 100d, and another end of the heat pipe unit 2d is suspended. Hence, heat generated by the light-emitting unit 3d can be effectively transmitted to the reflection-type lampshade unit 1d by using the heat pipe unit 2d, so that the present invention can generate high heat-dissipating efficiency.

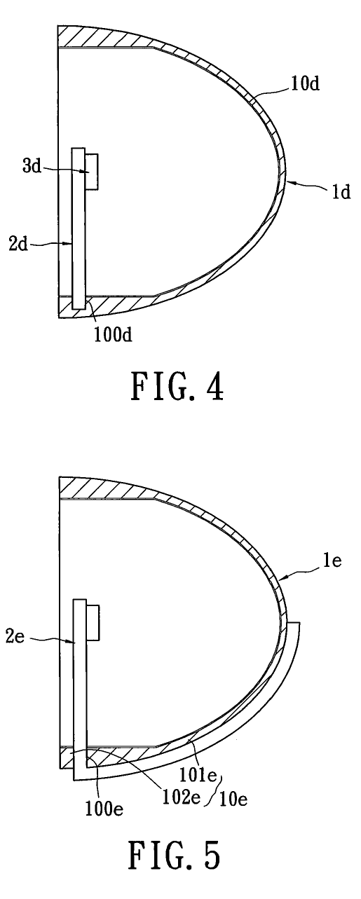

Referring to FIG. 5, the difference between the fifth embodiment and the fourth embodiment is that: in the fifth embodiment, the reflection-type lampshade unit 1e has at least one through hole 100e passing through the open casing 10e. The heat pipe unit 2e passes through the through hole 100e, so that one part of the heat pipe unit 2e is disposed on an outer surface of the open casing 10e. In addition, the open casing 10e has a casing portion 101e and a base portion 102e disposed under the casing portion 101e, and the one part of the heat pipe unit 2e is disposed on an outer surface of the casing portion 101e of the open casing 10e.

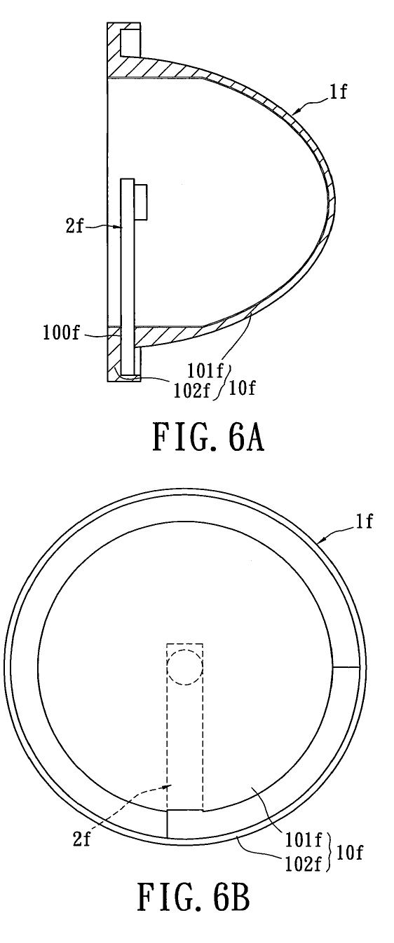

Referring to FIGS. 6A and 6B, in the sixth embodiment, the reflection-type lampshade unit 1f has at least one through hole 100f passing through the open casing 10f. The heat pipe unit 2f passes through the through hole 100f, so that one part of the heat pipe unit 2f is disposed on an outer surface of the open casing 10f. The difference between the sixth embodiment and the fifth embodiment is that: in the sixth embodiment, the open casing 10f has a casing portion 101f and a base portion 102f disposed under the casing portion 10f, and the one part of the heat pipe unit 2f is disposed on an outer surface of the base portion 102f of the open casing 10f.

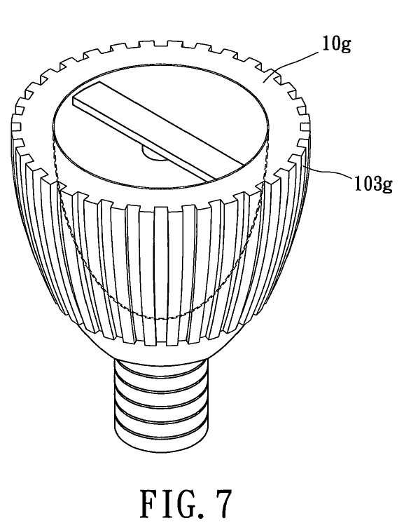

Referring to FIG. 7, the difference between the seventh embodiment and above-mentioned embodiments is that: the open casing 10g has a heat-dissipating structure 103g with heat-dissipating fins disposed on an outer surface thereof.

In conclusion, the present invention can generate high heat-dissipating efficiency (high heat-conducting efficiency) and high light-generating efficiency (high light utilization percent) by matching the heat pipe unit and a plurality of types of reflective structure (the first, second and third reflective structures).

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A reflection-type light-emitting module with high heat-dissipating and high light-generating efficiency, comprising:
a reflection-type lampshade unit having an open casing, a receiving space formed in the open casing, and a first reflective structure disposed in the receiving space and on an inner surface of the open casing;
a heat pipe unit received in the receiving space and disposed on the open casing; and
a light-emitting unit disposed on the heat pipe unit, wherein the light-emitting unit has a light-emitting face facing the inner surface of the open casing.

2. The reflection-type light-emitting module according to claim 1, wherein the open casing has a cup shape with an opening.

3. The reflection-type light-emitting module according to claim 1, wherein the inner surface of the open casing is a cambered surface.

4. The reflection-type light-emitting module according to claim 1, wherein the receiving space has a trapezoid.

5. The reflection-type light-emitting module according to claim 1, wherein the first reflective structure is a first reflective layer that is made of reflective material.

6. The reflection-type light-emitting module according to claim 1, wherein the first reflective structure is composed of a plurality of mirrors.

7. The reflection-type light-emitting module according to claim 1, wherein the open casing has at least two retaining grooves formed on the inner surface thereof, and two opposite ends of the heat pipe unit are respectively retained in the two retaining grooves.

8. The reflection-type light-emitting module according to claim 1, wherein the open casing has at least one retaining groove formed on the inner surface thereof, one end of the heat pipe unit is retained in the retaining groove, and another end of the heat pipe unit is suspended.

9. The reflection-type light-emitting module according to claim 1, wherein the reflection-type lampshade unit has at least one through hole passing through the open casing, and the heat pipe unit passes through the through hole, so that one part of the heat pipe unit is disposed on an outer surface of the open casing.

10. The reflection-type light-emitting module according to claim 9, wherein the open casing has a casing portion and a base portion disposed under the casing portion, and the one part of the heat pipe unit is disposed on an outer surface of the casing portion of the open casing.

11. The reflection-type light-emitting module according to claim 9, wherein the open casing is composed of a casing portion and a base portion disposed under the casing portion, and the one part of the heat pipe unit is disposed on an outer surface of the base portion of the open casing.

12. The reflection-type light-emitting module according to claim 1, further comprising: a second reflective structure disposed on the inner surface of the open casing, wherein the second reflective structure has a cone and a second reflective layer formed on the surface of the cone.

13. The reflection-type light-emitting module according to claim 12, wherein the cone is composed of a cone portion and a bottom portion under the cone portion, the cone portion faces the light-emitting unit, and the bottom portion is disposed on the inner surface of the open casing.

14. The reflection-type light-emitting module according to claim 1, further comprising: a third reflective structure disposed on the heat pipe unit, wherein the third reflective structure has a cone and a third reflective layer formed on the surface of the cone.

15. The reflection-type light-emitting module according to claim 14, wherein the cone is composed of a cone portion and a bottom portion under the cone portion, the cone portion faces downwards the first reflective structure, and the bottom portion is disposed on a bottom side of the heat pipe unit.

16. The reflection-type light-emitting module according to claim 1, wherein the open casing has a heat-dissipating structure with heat-dissipating fins disposed on an outer surface thereof.
